(19) United States
(12) Patent Application Publication
(10) Pub. No.: US 2025/0212172 A1
(43) Pub. Date: Jun. 26, 2025

(54) MULTI-MODAL FUSION COORDINATION DEVICE CORRELATION AND IDENTIFICATION

(71) Applicant: Cisco Technology, Inc., San Jose, CA (US)

(72) Inventors: Alan W. DUMDEI, Greenville, TX (US); Malcolm M. SMITH, Richardson, TX (US); Matthew A. SILVERMAN, Shaker Heights, OH (US); Jerome HENRY, Pittsboro, NC (US); Peiman AMINI, Fremont, CA (US); Ardalan ALIZADEH, Campbell, CA (US)

(21) Appl. No.: 18/929,435

(22) Filed: Oct. 28, 2024

Related U.S. Application Data
(60) Provisional application No. 63/613,705, filed on Dec. 21, 2023.

(51) Int. Cl. H04W 64/00; H04W 48/14; H04W 48/16

(52) U.S. Cl. CPC H04W 64/006; H04W 48/14; H04W 48/16

(57) ABSTRACT

Embodiments herein describe techniques for correlating ranging data sent using different ranging or location techniques by the same STA. By knowing the ranging data came from the same STA, an AP that received the ranging data (or other type of STA) can perform MMFC to determine a more accurate location or range of the STA than would be possible using only one location technique. In one embodiment, the STA uses a virtual MAC address when transmitting ranging/location data to the AP. For example, when transmitting ranging data, the STA can use the same virtual MAC address in those frames. In another embodiment, an ANQP message can be used to provide the AP with the MAC address(es) used by the STA. In yet another embodiment, an identity federation can be used to provide the AP with the MAC address(es) used by the STA.

### CROSS-REFERENCE TO RELATED APPLICATIONS

This application claims benefit of co-pending U.S. provisional patent application Ser. No. 63/613,705 filed Dec. 21, 2023. The aforementioned related patent application is herein incorporated by reference in its entirety.

### TECHNICAL FIELD

Embodiments presented in this disclosure generally relate to correlating ranging information generated using different location techniques to the same wireless station.

### BACKGROUND

Multi-Modal Fusion Coordination (MMFC) is the idea of using multiple methods to optimize ranging/location. When using multiple location techniques (e.g., ultra-wide band (UWB), fine time measurement (FTM), Bluetooth low energy (BLE)), a station (STA) first determines which measurements are made from the same device so they can be correlated. When MMFC capabilities are advertised and a first STA (e.g., a client device) initiates measurements with a second STA (e.g., an access point (AP)), the devices do not initially know who the signals belong to. For example, if the first STA (client) initiates the ranging process first with FTM but then adds UWB, the second STA (AP) would not know those ranging signals were generated by the same device (the first STA/client in this example) and hence would not understand that fusion benefits can be had.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 illustrates a system for using a virtual MAC address for correlating multiple ranging techniques, according to one embodiment.

FIG. 2 is a flowchart for using a virtual MAC address for correlating multiple ranging techniques, according to one embodiment.

FIG. 3 is an Access Network Query Protocol (ANQP) system, according to one embodiment.

FIG. 4 is a flow for using ANQP for exchanging ranging MAC addresses, according to one embodiment.

FIG. 5 illustrates using an identity federation to exchange ranging MAC addresses, according to one embodiment.

FIG. 6 is a flowchart for receiving ranging MAC addresses using an identity federation, according to one embodiment.

FIG. 7 depicts an example computing device configured to perform various aspects of the present disclosure, according to some embodiments of the present disclosure.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

One embodiment presented in this disclosure is a wireless STA that includes one or more processors and memory storing an application, which, when executed by any combination of the one or more processors performs an operation. The operation includes receiving a first wireless frame transmitted by a second STA where the first wireless frame is part of a first wireless location technique and comprises a virtual MAC address; receiving a second wireless frame transmitted by the second STA where the second wireless frame is part of a second wireless location technique different from the first wireless location technique where the second wireless frame comprises the virtual MAC address; determining that the first and second wireless frames are both from the second STA using the virtual MAC address; and combining location information in the first and second wireless frames to determine a location or range associated with the second STA.

Another embodiment in this disclosure is a wireless STA that includes one or more processors and memory storing an application, which, when executed by any combination of the one or more processors performs an operation. The operation includes receiving one or more MAC addresses used by a second STA when performing ranging in an exchange of ANQP messages; receiving a first wireless frame transmitted by the second STA where the first wireless frame is part of a first wireless location technique and comprises at least one of the one or more MAC addresses; receiving a second wireless frame transmitted by the second STA where the second wireless frame is part of a second wireless location technique different from the first wireless location technique and where the second wireless frame comprises at least one of the one or more MAC addresses; and combining location information in the first and second wireless frames to determine a location or range associated with the second STA.

Another embodiment in this disclosure is a wireless STA that includes one or more processors and memory storing an application, which, when executed by any combination of the one or more processors performs an operation. The operation includes determining that an identity federation has authenticated a second STA; receiving, from the identity federation, one or more MAC addresses used by the second STA when performing ranging; receiving a first wireless frame transmitted by the second STA where the first wireless frame is part of a first wireless location technique and comprises at least one of the one or more MAC addresses; receiving a second wireless frame transmitted by the second STA where the second wireless frame is part of a second wireless location technique different from the first wireless location technique where the second wireless frame comprises at least one of the one or more MAC addresses; and combining location information in the first and second wireless frames to determine a location or range associated with the second STA.

### Example Embodiments

Embodiments herein describe techniques for correlating ranging data sent using different ranging or location techniques (e.g., UWB, FTM, BLE, etc.) by the same STA (e.g., the same client device). By knowing the ranging data came from the same STA, an AP that received the ranging data (or other type of STA) can perform MMFC to determine a more accurate location or range of the STA than would be possible using only one location technique. In one embodiment, the STA uses a virtual MAC address when transmitting ranging/location data to the AP. For example, when transmitting wireless frames with ranging/location data, the STA can use the same virtual MAC address in those frames, regardless whether those frames are UWB frames, BLE frames, Wi-Fi frames, etc. If the AP detects the virtual address, the AP determines the wireless frames were sent by the same STA, and thus, MMFC can be performed. In contrast, when transmitting non-ranging data (e.g., normal Wi-Fi or BLE traffic), the STA can use the physical MAC address assigned to the corresponding radio, instead of the virtual MAC address. In this embodiment, the virtual MAC address is reserved for wireless frames transmitting ranging data while other data is transmitted using the physical (different) MAC addresses assigned to each radio.

In one embodiment, Access Network Query Protocol (ANQP) can be used to exchange ranging MAC addresses between two STAs (e.g., between a client device and an AP). This can be done without the client device ever associating with the Wi-Fi AP. In one embodiment, the AP can use an ANQP message to inform the client device which location techniques it supports. The client device can then determine which of those location techniques it also supports and respond to the AP using an ANQP message. In addition, this message (or a follow up message) can include the MAC addresses (whether the physical MAC addresses or a virtual MAC addresses) that the client device will use when transmitting wireless frames containing ranging data. That way, the AP can identify wireless frames containing ranging data from the same client device and perform MMFC.

In another embodiment, an identify federation can be used to provide a first STA (e.g., an AP) with ranging MAC addresses used by a second STA (e.g., a client device). An identity federation is a system of trust between two parties for the purpose of authenticating users and conveying information needed to authorize their access to resources. Identity federations (such as OpenRoaming) are typically used in the Wi-Fi context by a network provider to authenticate a client device so it can join the network. In addition to performing this role, the identity federation can provide the ranging MAC addresses used by the client device to the network provider. That way, the AP can identify wireless frames containing ranging data from the same client device and perform MMFC.

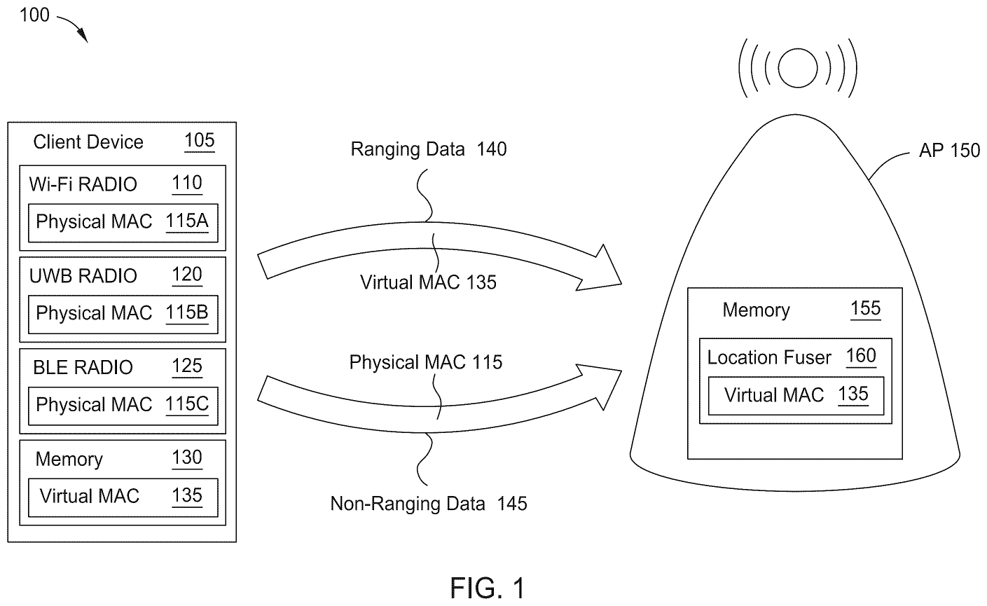

FIG. 1 illustrates a system 100 for using a virtual MAC address 135 for correlating multiple ranging techniques, according to one embodiment. The system 100 illustrates an AP 150 (e.g., a first STA) communicating with a client device 105 (e.g., a second STA). In this example, the client device 105 includes a Wi-Fi radio 110, a UWB radio 120, and a BLE radio 125. In this example, it is assumed these radios each have a different physical MAC address 115A-C. For example, the MAC addresses 115A-C may be assigned by the manufacturer of the radios. Typically, when transmitting a wireless frame (or packet) from the radio, the frame would include the corresponding physical MAC 115. Thus, while the frames are transmitted from the same client device 105, the wireless frames transmitted by the different radios have different physical MAC addresses 115.

The client device 105 may use the different radios to perform different location techniques—e.g., a location technique using Wi-Fi (e.g., FTM), a location technique using UWB, and a location technique using BLE. When the AP 150 receives wireless frames for these different location techniques, if the frames include the physical MACs 115, the AP 150 would not know they came from the same device 105. The AP 150 would then be unable to fuse the location information using MMFC.

Instead, in one or more embodiments, the client device 105 includes a memory 130 (e.g., non-volatile memory) that stores a virtual MAC address 135 that is used by the client device when transmitting ranging data 140 to the AP 150 (e.g., wireless frames that includes location or ranging information). Thus, when performing a location or ranging technique using one of the radios 110, 120, or 125, instead of transmitting their corresponding physical MAC address 115, the client device 105 transmits the virtual MAC address 135 in the frame. Thus, regardless whether the location technique is transmitted using Wi-Fi, UWB, or BLE, the frames or packets containing the ranging data 140 contain the same virtual MAC address 135.

In contrast, when the client device 105 transmits non-ranging data 145 (e.g., user data, association data, control data, and the like), the frames and packets containing the non-ranging data 145 can use the physical MAC addresses 115 (depending on which radio is transmitting the non-ranging data 145). Thus, in this example, the virtual MAC address 135 is reserved for ranging data 140 generated by performing a location technique using one of the radios 110, 120, and 125.

The AP 150 receives the ranging data 140 and the non-ranging data 145 from the client device 105. The AP 150 includes memory 155 that contains a location fuser 160 (e.g., a software application) that stores the virtual MAC address 135. That is, the AP 150 knows the virtual MAC address 135 used by the client device 105 when transmitting the ranging data 140. As such, when receiving wireless frames from the client device 105, the location fuser 160 can evaluate the MAC addresses in the frames to determine whether they match the virtual MAC address 135. If so, the location fuser 160 can determine that the frame was transmitted by the same client device 105, and can also determine that the frame contains ranging data 140. If the AP 150 receives ranging data 140 generated using different types of location techniques, the location fuser 160 can perform MMFC to determine a location or range of the client device 105.

Although not shown, the AP 150 can also include one or more Wi-Fi radios, UWB radios, and BLE radios so it can receive (and transmit) the ranging data 140 and the non-ranging data 145. The AP 150 can include different antennas used by the different radios.

While FIG. 1 illustrates using a virtual MAC address when transmitting ranging data 140 between a client device and AP, a virtual MAC address could be used when transmitting ranging data between the AP and a client device, or between two APs, or between two client devices. In general, the embodiments herein can be used between any two wireless STAs.

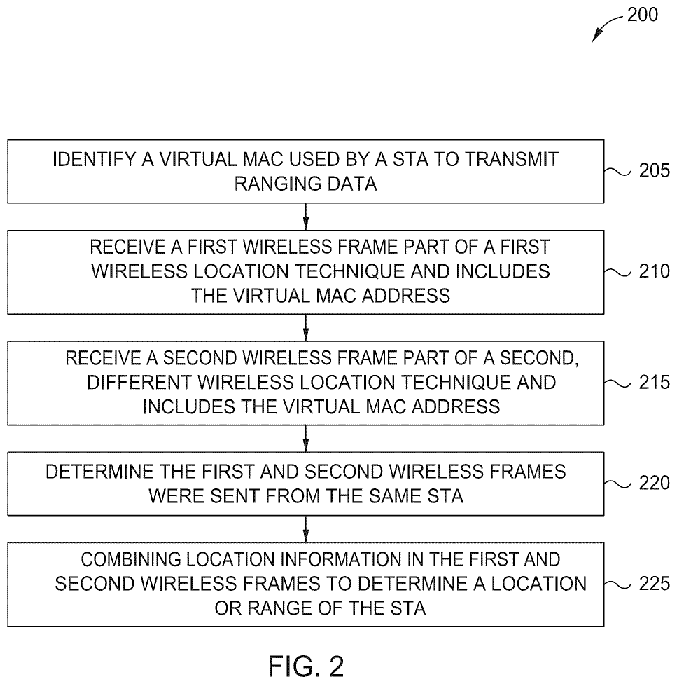

FIG. 2 is a flowchart of a method 200 for using a virtual MAC address for correlating multiple ranging techniques, according to one embodiment. At block 205, the AP (e.g., a first STA) identifies a virtual MAC address used by a STA (e.g., a client device) to transmit ranging data. There are several different techniques for informing the AP of the virtual MAC address used by the STA when transmitting ranging data. In one embodiment, the virtual MAC address may be set by a standard (e.g., an IEEE standard) or an alliance which informs the AP where to look to identify the virtual MAC address. For example, a UWB MAC address is typically 64 bits. A virtual 48 bit MAC could be formed using the least significant 48 bits of the UWB MAC address. That is, the least significant 48 bits of the UWB MAC address could also be used as the BLE MAC address and Wi-Fi MAC address when transmitting ranging data from the same client device. In this manner, the client device knows (according to standard or the alliance) that it should use the least significant 48 bits of the UWB MAC address as the virtual MAC address for transmitting ranging data, regardless of the type of location technique being used. In turn, the AP knows (according to standard or the alliance) that the same device will use the same virtual MAC address for all location messages. When the AP processes the ranging measurement with this virtual MAC address it can correlate that signal to the same device with a simple binary match.

In another embodiment, the virtual MAC address can be shared with the AP during a discovery process. For example, when associating when a basic service set (BSS) established by the AP, as part of the discovery process, the client device can send its virtual MAC address to the AP. Alternatively, the AP could send a virtual MAC address to the client device during the discovery process. For example, in a probe response, one of the information elements (IE) in the response could indicate the virtual MAC address that should be used when transmitting ranging data. The client device would then use that virtual MAC address when transmitting ranging data.

At block 210, the AP receives a first wireless frame that is part of a first wireless location technique from the client device. This wireless frame includes the virtual MAC address.

At block 215, the AP receives a second wireless frame that is part of a second wireless location technique that is different from the first wireless location technique in block 210. For example, the wireless frame received at block 210 may be a Wi-Fi ranging technique while the wireless frame received at block 215 may be a UWB or BLE ranging technique. Moreover, the wireless frames at blocks 210 and 215 may be transmitted using two different radios at the client device, and may be received by two different radios in the AP.

Moreover, the second wireless frame includes the same virtual MAC address that was in the first wireless frame, despite being associated with two different radios. In one embodiment, these radios have two different physical MAC address which are used instead of the virtual MAC address when the client device is sending data other than ranging data to the AP.

At block 220, the AP determines that the first and second wireless frames were sent from the same client device (e.g., the same STA). In one embodiment, the AP makes this correlation because the first and second wireless frames have the same virtual MAC address.

At block 225, the AP combines location information in the first and second wireless frames to determine a location or range of the client device (e.g., the STA). For example, the AP can perform MMFC to use location information from the two (or more) different ranging techniques to identify a location of the client device. This can be a relative location of the client device to the AP (e.g., a distance and/or direction) or a geographic position of the client device (e.g., a location of the client device in a room). The embodiments herein are not limited to any particular type of MMFC algorithm or technique.

While FIG. 2 discusses using a virtual MAC address when transmitting ranging data between a client device and AP, a virtual MAC address could be used when transmitting ranging data between the AP and a client device, or between two APs, or between two client devices. In general, the embodiments herein can be used between any two wireless STAs.

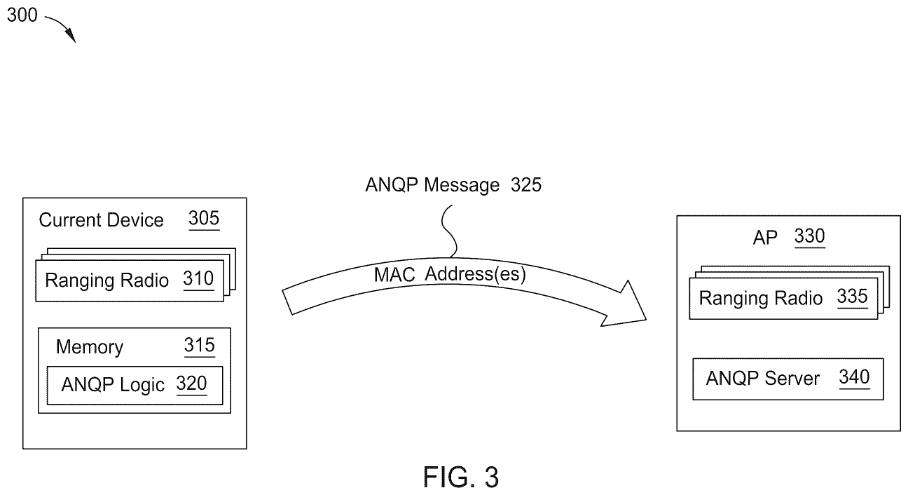

FIG. 3 is an ANQP system 300, according to one embodiment. The ANQP system 300 includes a client device 305 and an AP 330 where the client device 305 uses an ANQP message 325 to inform the AP 330 of the MAC address (or addresses) that the client device 305 will use when transmitting ranging data. However, the system 300 could alternatively work in the different direction where the AP 330 uses an ANQP message to instruct the client device 305 what MAC address (or addresses) to use when transmitting ranging data.

The client device 305 includes multiple ranging radios 310 which can be, e.g., a Wi-Fi radio, a UWB radio, a BLE radio, etc. In this example, it is assumed these radios 310 each have a different physical MAC address, like as shown in FIG. 1. Typically, when transmitting a wireless frame (or packet) from one of the radios 310, the frame would include the corresponding physical MAC. Thus, while the frames are transmitted from the same client device 305, the wireless frames transmitted by the different radios have different physical MAC addresses.

Like in FIG. 1, the client device 305 may use the different radios 310 to perform different location techniques—e.g., a location technique using Wi-Fi (e.g., FTM), a location technique using UWB, and a location technique using BLE. When the AP 330 receives wireless frames for these different location techniques, if the frames include the physical MACs, the AP 330 would not know they came from the same device 305, and thus, would not know it could fuse the location information using MMFC.

In one or more embodiments, the client device 305 uses the ANQP message 325 to inform the AP 330 the MAC address (or addresses) that is used by the client device 305 when transmitting ranging data to the AP 330 (e.g., wireless frames that includes location or ranging information). In one embodiment, the ANQP message 325 may include a virtual MAC address that the client device 305 uses when transmitting ranging data uses the radios 310, as discussed in FIGS. 1 and 2. However, in another embodiment, the ANQP message 325 may include the physical MAC addresses corresponding to each of the ranging radios 310. As such, because the client device 305 explicitly tells the AP 330 which MAC address (or addresses) will be used for ranging, the system 300 permits the client device 305 to use the normal, physical MAC addresses of the radios 310, or use a special virtual MAC address when transmitting ranging data. Thus, the AP 330 can determine when these frames came from the same client device 305.

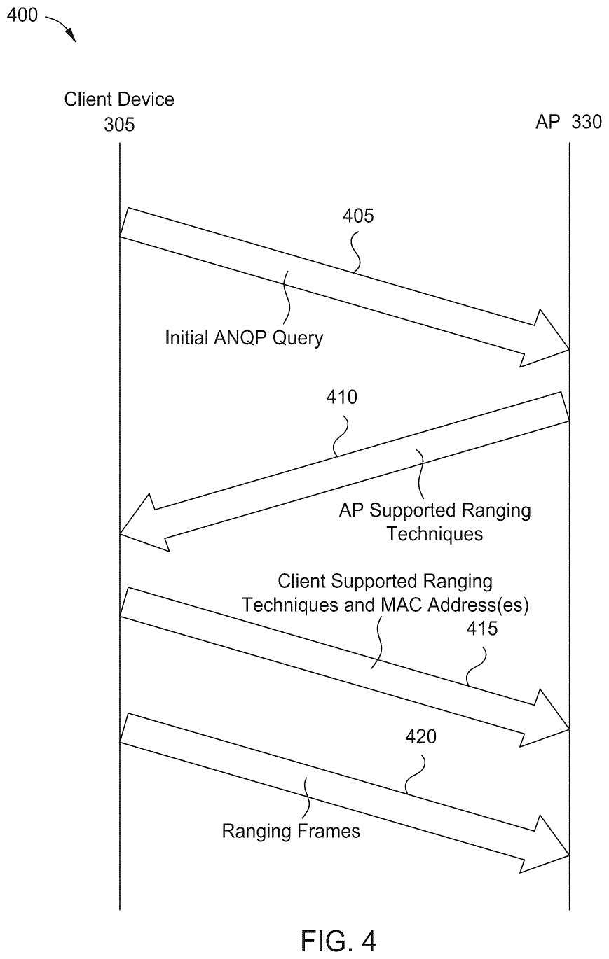

The client device 305 includes a memory 315 which stores ANQP logic 320. The ANQP logic 320 can prepare and send the ANQP message 325 without the client device 305 ever associating with the Wi-Fi AP 330. Further, in addition to using ANQP to inform the AP 330 of the MAC address(es) used during ranging, the ANQP logic 320 (e.g., software or firmware) can include in the ANQP message 325 (or in other messages) the types of location techniques it supports. Although not shown, the AP 330 can also use ANQP message(s) to inform the client device 305 of the types of location techniques it supports. That way, the client device 305 and the AP 330 can use the types of location techniques they both support to perform ranging. This is discussed in more detail in FIG. 4.

The AP 330 also includes ranging radios 335 such as one or more Wi-Fi radios, UWB radios, and BLE radios so it can communicate with the ranging radios 310 in the client device 305. These radios 335 can have different antennas.

The AP 330 further includes an ANQP server 340 (e.g., established by an ANQP software application) for interpreting the ANQP message 325 as well as transmitting ANQP messages to the client device 305. One benefit of using ANQP to identify the different ranging techniques supported by the client device 305 and the AP 330 as well as the associated MAC addresses is that this can occur out-of-band where the location techniques that are used can be negotiated. For example, ranging can be done through BLE and UWB to determine a location of the client device 305 (assuming the client device 305 has those radios 310) without the client device 305 ever joining the Wi-Fi network established by the AP 330.

FIG. 4 is a flow 400 for using ANQP for exchanging ranging MAC addresses, according to one embodiment. The flow 400 illustrates some of the messages that can be exchanged between the client device 305 and the AP 330 introduced in FIG. 3.

The client device 305 transmits an initial ANQP query 405 to the AP 330. This can be performed before the client device 305 has associated with the Wi-Fi network established by the AP 330.

The AP 330 transmits a response 410 that includes a list of ranging techniques that are supported by the AP (e.g., Wi-Fi, BLE, UWB, etc.).

The ANQP logic in the client device 305 can determine which of the ranging techniques that are supported by the AP that the client device 305 also supports. For example, the AP may support Wi-Fi, BLE, and UWB while the client device 305 only supports Wi-Fi and BLE. In this case, the client device 305 and the AP 330 could use Wi-Fi and BLE to perform ranging, which is a subset of the location techniques supported by the AP 330. Or the AP may support Wi-Fi and UWB while the client device 305 supports Wi-Fi, BLE, and UWB. In this case, the client device 305 and the AP 330 could use Wi-Fi and UWB to perform ranging, which is a subset of the location techniques supported by the client device 305.

Once the client device 305 determines which of the AP's ranging techniques it also supports, the client device 305 transmits the response 415 which informs the AP 330 which of the AP's location technique it too supports, as well as the MAC address(es) used by those ranging techniques. For example, the response 415 can include a list of location techniques both the client device 305 and the AP 330 support. As discussed above, these MAC addresses could be the physical MAC addresses used by the radios of the supported ranging techniques. In that case, the client device 305 could use the same MAC addresses regardless whether the client device 305 is transmitting ranging data or other data on its radios.

Alternatively, the client device 305 can send a virtual MAC address in the ANQP response 415 that the client device 305 uses when transmitting ranging data, regardless of the radio that is transmitting the ranging data. That is, the client device 305 may use the virtual MAC address only when sending ranging data but use the normal physical MAC address when transmitting other types of data using these radios.

Now that the client device 305 has informed the AP 330 of what ranging techniques it will use, and the MAC address(es) associated with those techniques, the client device 305 can transmit ranging frames 420 (which are not ANQP messages) to the AP 330. These frames 420 can include the MAC address(es) that were identified in the ANQP response 415. That way, the AP 330 can use the MAC address(es) to correlate the wireless frames as being sent by the same client device 305. This can trigger the AP 330 to perform MMFC as discussed above. That is, the AP can receive multiple wireless frames that are part of different wireless locations techniques from the client device as described in blocks 210-225 of FIG. 2, determine these wireless frames are from the same client device, and perform MMFC.

Moreover, if the ranging frames 420 do not use a Wi-Fi ranging technique (e.g., the ranging frames 420 are part of BLE and UWB ranging techniques), then the client device 305 does not have to join the Wi-Fi network. However, if the client device 305 informed the AP 330 in the response 415 that a Wi-Fi ranging technique will be used, then the client device 305 may have joined the Wi-Fi network prior to transmitting the ranging frames 420.

While FIG. 4 discusses using ANQP to exchange MAC addresses for transmitting ranging data between a client device and AP, ANQP could be used when transmitting ranging data from the AP to a client device, or between two APs, or between two client devices. In general, the embodiments herein can be used between any two wireless STAs which support ANQP.

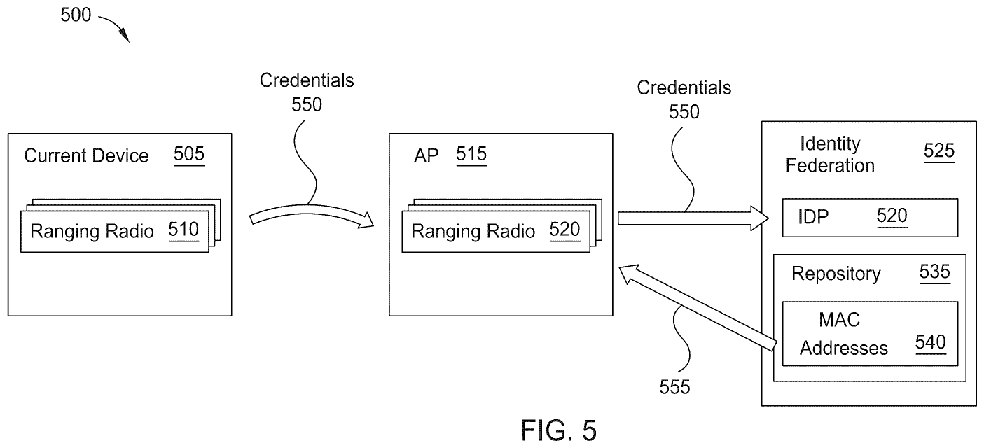

FIG. 5 illustrates a system 500 that uses an identity federation 525 to exchange ranging MAC addresses 540, according to one embodiment. In an identity federation 525, services can join together to share credentials and user identities to determine how and whether to provide access to an associated service (e.g., access to a Wi-Fi network) based on an identity used by other services in the identity federation 525.

Identity providers (IDPs) 530 are entities that users can create and manage various identities through which the network provider may delegate authentication functions to. For example, the user of the client device 505 can register with the IDP 530 of a social network to gain access to the wireless network supported by the AP 515 by authenticating with the social network, which in turn, vouches for the authenticity of the user credentials and identifies the user to the network provider (which includes the AP 515). Accordingly, the network provider, as a service provider, can avoid the need to set up individual accounts for each user attempting to gain access to the wireless network, and instead rely on one or more trusted IDPs 530 to verify the identity of the requesting users. In various embodiments, the services of an IDP 530 can be an on-premises authentication service shared by several service providers in the wireless network or an off-premises authentication service (e.g., a cloud-based service) used by several service providers offering one or several wireless networks.

FIG. 5 illustrates the client device 505 providing credentials 550 which can be used to verify the identity of the client device to the trusted IDP 530. In this example, the AP 515 receives the credentials 550 and forwards them to the IDP 530. For example, the credentials 550 may be to log into a service provided by the IDP 530 (e.g., login information to a social medial account or an email account).

Once authenticated by the IDP 530, the AP 515 grants access to the client device 505 to the Wi-Fi network. In various embodiments, the credentials 550 can include the provision of a user name and associated with a given realm or domain (e.g., username at roaming.example.com, username at identities.example.co.uk), a password, authentication details (e.g., an answer to a security question), multifactor authentication confirmation, and the like.

In addition to using the identity federation 525 to authenticate the client device 505 in order to access the Wi-Fi network established by the AP 515, the system 500 also uses the identity federation 525 to provide the AP 515 with the MAC addresses 540 used for ranging. For example, when selling a device (such as the client device 505), the manufacture or vendor may store the MAC addresses 540 the device uses for transmitting ranging information in a repository 535 of the identity federation 525. Once authenticated by the IDP 530, the identity federation 525 can query the repository 535 to determine whether it stores MAC addresses 540 for ranging. If so, in addition to authenticating the client device 505 for the AP 515, the identify federation 525 can inform the AP 515 of the MAC addresses 540 the client device 505 uses for ranging.

The client device 505 includes multiple ranging radios 510 which can be, e.g., a Wi-Fi radio, a UWB radio, a BLE radio, etc. In this example, it is assumed these radios 510 each have a different physical MAC address, like as shown in FIG. 1. Typically, when transmitting a wireless frame (or packet) from one of the radios 510, the frame would include the corresponding physical MAC. Thus, while the frames are transmitted from the same client device 505, the wireless frames transmitted by the different radios have different physical MAC addresses.

Like in FIG. 1, the client device 505 may use the different radios 310 to perform different location techniques—e.g., a location technique using Wi-Fi (e.g., FTM), a location technique using UWB, and a location technique using BLE. When the AP 330 receives wireless frames for these different location techniques, if the frames include the physical MACs, the AP 515 would not know they came from the same device 505, and thus, would not know it could fuse the location information using MMFC. However, this is resolved by the identity federation 525 providing the ranging MAC addresses 540 used by the client device 505 to the AP 515.

In one embodiment, the MAC address 540 may include a virtual MAC address that the client device 505 uses when transmitting ranging data uses the radios 510, as discussed in FIGS. 1 and 2. However, in another embodiment, the MAC addresses 540 may include the physical MAC addresses corresponding to each of the ranging radios 510. As such, because the identity federation 525 provides the AP 515 with the MAC address (or addresses) that will be used for ranging, the system 500 permits the client device 505 to use the normal, physical MAC addresses of the radios 510, or use a special virtual MAC address when transmitting ranging data. Thus, the AP 515 can determine when these frames came from the same client device 505.

The AP 515 also includes ranging radios 520 such as one or more Wi-Fi radios, UWB radios, and BLE radios so it can communicate with the ranging radios 510 in the client device 505. These radios 520 can have different antennas.

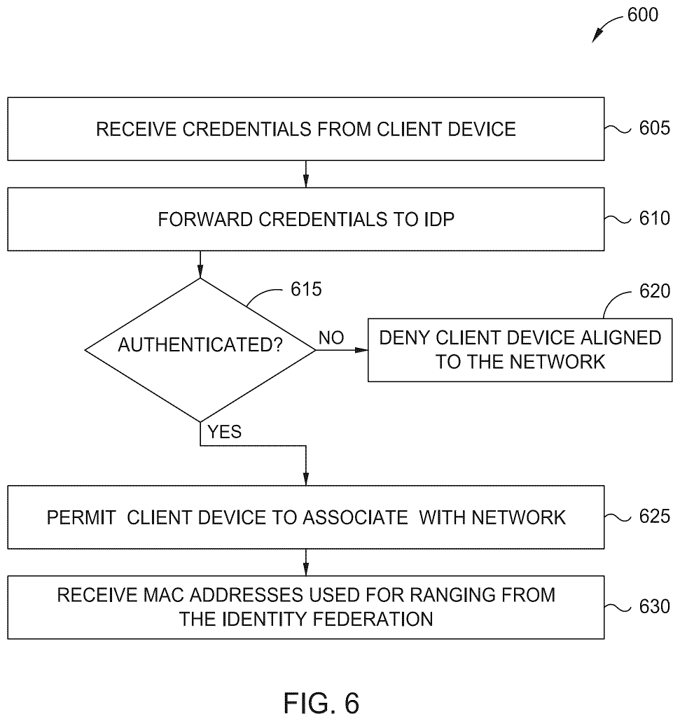

FIG. 6 is a flowchart of a method 600 for receiving ranging MAC addresses using an identity federation, according to one embodiment. At block 605, the AP receives credentials from a client device. The credentials may be used by an IDP in an identity federation in order to authenticate the client device on behalf of the AP. For example, the credentials may be login information for a user of the client device to a service (e.g., social media, email account, etc.) provided by the IDP.

At block 610, the AP forwards the credentials to the IDP.

At block 615, the AP determines whether the IDP authenticated the client device. If not, the method 600 proceeds to block 620 where the AP denies the client device access to its network.

However, if authenticated by the IDP, the method 600 proceeds to block 625 where the AP permits the client device to associate with the network (e.g., the Wi-Fi network).

At block 630, the AP receives MAC addresses used for ranging from the identity federation. These MAC addresses can be a virtual MAC address used by each of the different radios in the client device when transmitting ranging data, or the MAC addresses can be the physical MAC addresses for the radios. The AP can then use the MAC addresses to identify when wireless frames containing ranging information that originate from the same client device, and in response, perform MMFC. That is, the AP can receive multiple wireless frames that are part of different wireless locations techniques from the client device as described in blocks 210-225 of FIG. 2, determine these wireless frames are from the same client device, and perform MMFC.

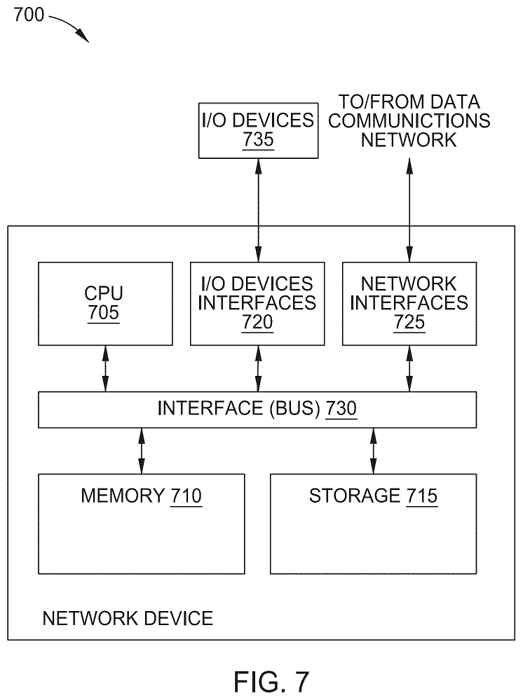

FIG. 7 depicts an example computing device or a computing system (e.g., a network device 700) configured to perform various aspects of the present disclosure, according to some embodiments of the present disclosure. In some embodiments, the network device 700 corresponds to a computing device that includes or implements the APs or the client devices illustrated in the Figures above. Although depicted as a physical device, in embodiments, the network device 700 may be implemented using virtual device(s), and/or across a number of devices (e.g., in a cloud environment).

As illustrated, the network device 700 includes a CPU 705, memory 710, storage 715, a network interface 725, and one or more I/O interfaces 720. In the illustrated embodiment, the CPU 705 (e.g., one or more processors) retrieves and executes (or performs) programming instructions stored in memory 710, as well as stores and retrieves application data residing in storage 715. The CPU 705 is generally representative of a single CPU and/or graphics processing unit (GPU), multiple CPUs and/or GPUs, a single CPU and/or GPU having multiple processing cores, and the like. The memory 710 is generally included to be representative of a random access memory. Storage 715 may be any combination of disk drives, flash-based storage devices, and the like, and may include fixed and/or removable storage devices, such as fixed disk drives, removable memory cards, caches, optical storage, network attached storage (NAS), or storage area networks (SAN).

In some embodiments, I/O devices 735 (such as keyboards, monitors, etc.) are connected via the I/O interface(s) 720. Further, via the network interface 725, the network device 700 can be communicatively coupled with one or more other devices and components (e.g., via a network, which may include the Internet, local network(s), and the like). As illustrated, the CPU 705, memory 710, storage 715, network interface(s) 725, and I/O interface(s) 720 are communicatively coupled by one or more buses 730.

In the illustrated embodiment, the memory 710 can include any software application which may perform one or more embodiments discussed above in FIGS. 1-6 where an AP can identify wireless frames containing ranging information that originates from the same client device. Although depicted as discrete components for conceptual clarity, in embodiments, the operations of the depicted components (and others not illustrated) may be combined or distributed across any number of components. Further, although depicted as software residing in memory 710, in embodiments, the operations of the depicted components (and others not illustrated) may be implemented using hardware, software, or a combination of hardware and software.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. A wireless station (STA), comprising:
one or more processors; and
memory storing an application, which, when executed by any combination of the one or more processors performs an operation comprising:
receiving a first wireless frame transmitted by a second STA, wherein the first wireless frame is part of a first wireless location technique and comprises a virtual MAC address;
receiving a second wireless frame transmitted by the second STA, wherein the second wireless frame is part of a second wireless location technique different from the first wireless location technique, wherein the second wireless frame comprises the virtual MAC address;
determining that the first and second wireless frames are both from the second STA using the virtual MAC address; and
combining location information in the first and second wireless frames to determine a location or range associated with the second STA.

2. The wireless STA of claim 1, wherein one of the first or second wireless location techniques is ultra-wide band (UWB), fine time measurement (FTM), or Bluetooth low energy (BLE).

3. The wireless STA of claim 1, wherein the wireless STA is an access point (AP), the operation further comprising:
receiving, at the AP, the virtual MAC address from the second STA during a discovery process.

4. The wireless STA of claim 1, wherein the operation further comprises:
receiving a third wireless frame transmitted by the second STA, wherein the third wireless frame is not part of wireless location technique, wherein the third wireless frame comprises a different MAC address than the virtual MAC address.

5. The wireless STA of claim 1, wherein the first wireless frame is received using a first antenna on the wireless STA for the first wireless location technique, and the second wireless frame is received using a second antenna on the wireless STA for the second wireless location technique.

6. The wireless STA of claim 1, wherein the wireless STA is an AP, the operation further comprising:
receiving, at the AP, the virtual MAC address from the second STA using an exchange of access network query protocol (ANQP) messages.

7. The wireless STA of claim 1, wherein the wireless STA is an AP, the operation further comprising:
receiving, at the AP, the virtual MAC address from an identify federation to which the second STA belongs.

8. A wireless STA, comprising:
one or more processors; and
memory storing an application, which, when executed by any combination of the one or more processors performs an operation comprising:
receiving one or more MAC addresses used by a second STA when performing ranging in an exchange of ANQP messages;
receiving a first wireless frame transmitted by the second STA, wherein the first wireless frame is part of a first wireless location technique and comprises at least one of the one or more MAC addresses;
receiving a second wireless frame transmitted by the second STA, wherein the second wireless frame is part of a second wireless location technique different from the first wireless location technique, wherein the second wireless frame comprises at least one of the one or more MAC addresses; and
combining location information in the first and second wireless frames to determine a location or range associated with the second STA.

9. The wireless STA of claim 8, wherein one of the first or second wireless location techniques is ultra-wide band (UWB), fine time measurement (FTM), or Bluetooth low energy (BLE).

10. The wireless STA of claim 8, wherein the first wireless frame is received using a first antenna on the wireless STA for the first wireless location technique, and the second wireless frame is received using a second antenna on the wireless STA for the second wireless location technique.

11. The wireless STA of claim 8, wherein the exchange of ANQP messages comprises:
receiving an initial ANQP query from the second STA;
transmitting an ANQP response to the second STA, wherein the ANQP response comprises a list of location techniques supported by the wireless STA; and
receiving an ANQP message from the second STA comprising a list of location techniques supported by the second STA.

12. The wireless STA of claim 11, wherein the list of location techniques supported by the second STA is a subset of the list of location techniques supported by the wireless STA.

13. The wireless STA of claim 12, wherein the one or more MAC addresses correspond to the subset.

14. The wireless STA of claim 13, wherein the one or more MAC addresses comprises multiple physical MAC addresses used by the subset.

15. The wireless STA of claim 13, wherein the one or more MAC addresses is a single virtual MAC address used by the subset.

16. A wireless station (STA), comprising:
one or more processors; and
memory storing an application, which, when executed by any combination of the one or more processors performs an operation comprising:
determining that an identity federation has authenticated a second STA;
receiving, from the identity federation, one or more MAC addresses used by the second STA when performing ranging;
receiving a first wireless frame transmitted by the second STA, wherein the first wireless frame is part of a first wireless location technique and comprises at least one of the one or more MAC addresses;
receiving a second wireless frame transmitted by the second STA, wherein the second wireless frame is part of a second wireless location technique different from the first wireless location technique, wherein the second wireless frame comprises at least one of the one or more MAC addresses; and
combining location information in the first and second wireless frames to determine a location or range associated with the second STA.

17. The wireless STA of claim 16, wherein one of the first or second wireless location techniques is ultra-wide band (UWB), fine time measurement (FTM), or Bluetooth low energy (BLE).

18. The wireless STA of claim 16, wherein the first wireless frame is received using a first antenna on the wireless STA for the first wireless location technique, and the second wireless frame is received using a second antenna on the wireless STA for the second wireless location technique.

19. The wireless STA of claim 16, wherein the one or more MAC addresses comprises multiple physical MAC addresses used by different radios in the second STA.

20. The wireless STA of claim 13, wherein the one or more MAC addresses is a single virtual MAC address used by different radios in the second STA when performing the first and second wireless location techniques.
